(19) United States
(12) Patent Application Publication
(10) Pub. No.: US 2017/0073249 A1
(43) Pub. Date: Mar. 16, 2017

(54) CONTAINER FOR A FILTER CARTRIDGE AND FILTER SET

(71) Applicant: Elysator Genossenschaft, Bilten (CH)

(72) Inventor: Manuel Rickenbach, Zurich (CH)

(21) Appl. No.: 15/267,017

(22) Filed: Sep. 15, 2016

(30) Foreign Application Priority Data
Sep. 15, 2015 (CH) 1339/15

(51) Int. Cl. C02F 1/42; B01D 61/02; C02F 1/44

(52) U.S. Cl. CPC C02F 1/42; C02F 1/441; B01D 61/025; C02F 2201/005; B01D 2313/18; B01D 2313/04; B01D 2311/2623

(57) ABSTRACT

The disclosure relates to a container for a filter cartridge, and a filter set which comprises such a container. The container has a bottom with a drain line connecting a cavity for accommodating the filter cartridge with the outer side of the container, and a side wall. The bottom and the side wall form the cavity. The filter cartridge is filled with a filter material. In order to enable utilisation of both ion exchanger filter cartridges and reverse osmosis filter cartridges, the drain line includes an extension that can receive a throttle valve, e.g. an apertured diaphragm, when using a reverse osmosis filter cartridge and, in addition, includes a ball valve that is closed when the inserted filter cartridge is an ion exchanger filter cartridge, and open otherwise.

### RELATED APPLICATIONS

This application claims the benefit under 35 USC §119 to Switzerland Patent Application Serial Number 1339/15, filed on Sep. 15, 2015, which is incorporated by reference herein in its entirety.

### FIELD

The invention concerns a container for a filter cartridge, and a filter set comprising such a container as well as at least two different filter cartridges. Filter cartridges of the type used herein are mainly employed in the filtering, especially the desalination, of water.

### BACKGROUND

Both ion exchanger cartridges and reverse osmosis cartridges have been known for a long time. They both have specific advantages and disadvantages. Ion exchanger cartridges offer high filtering capacity, and they do not produce concentrate. However, the ion exchange resin has to be replaced from time to time, causing rather high expenses. With reverse osmosis cartridges, the costs per liter of clean water are lower, but their production capacity is also lower, and they produce a concentrate, mostly wastewater, that has to be disposed of.

Containers for ion exchanger cartridges which have a closed bottom, and containers of the generic type that are suitable for reverse osmosis cartridges, where a suitable drain for the concentrate is provided in the bottom, are also known.

### SUMMARY

The object of the invention is to provide a container for filter cartridges into which both ion exchanger filter cartridges and reverse osmosis filter cartridges can be inserted. This object is achieved by the invention as characterised in the claims. A filter set is also provided in the claims which comprises a container according to the invention and at least one ion exchanger filter cartridge and at least one reverse osmosis filter cartridge, respectively.

The invention allows to utilize an ion exchanger filter cartridge or a reverse osmosis filter cartridge, depending on the conditions of use and the preferences. Thus, it is possible to exploit the advantages of one or the other type of filter cartridge according to the requirements that are currently prioritized.

### BRIEF DESCRIPTION OF THE DRAWINGS

In the following the invention is described in more detail with reference to drawings showing only an embodiment.

FIG. 1 shows a longitudinal section through a container according to the invention with an ion exchanger filter cartridge inserted therein, and

FIG. 2 shows a longitudinal section through a container according to the invention with a reverse osmosis filter cartridge inserted therein.

### DETAILED DESCRIPTION

The container 1 is preferably made of plastics and approximately cylindrical and has a bottom 2 and a circumferential side wall 3 adjoining the bottom 2 at its edge, both forming a cavity 4 having a round opening on the side opposite the bottom 2. The upper side of the bottom 2 facing the opening has a circumferential edge area 5 adjoining the side wall 3, the edge area having a circumferential groove in which a sealing ring 6 is arranged. The edge area 5 surrounds a central depression 7 on the upper side of the bottom 2. A drain line 8 passing through the bottom 2 connects an outlet opening 9 in the depression 7 with a drain opening 10 arranged laterally at the lower end of the container 1.

On the outlet opening 9, a socket for a throttle valve is provided, the socket being configured as a coaxial cylindrical extension 11 of a short portion of the drain line 8, the throttle valve being insertable into or removable from the socket via the cavity 4, or being rigidly connected to the bottom 2. Between the outlet opening 9 and the drain opening 10, a stop valve, configured as a ball valve 12, is provided in the drain line 8.

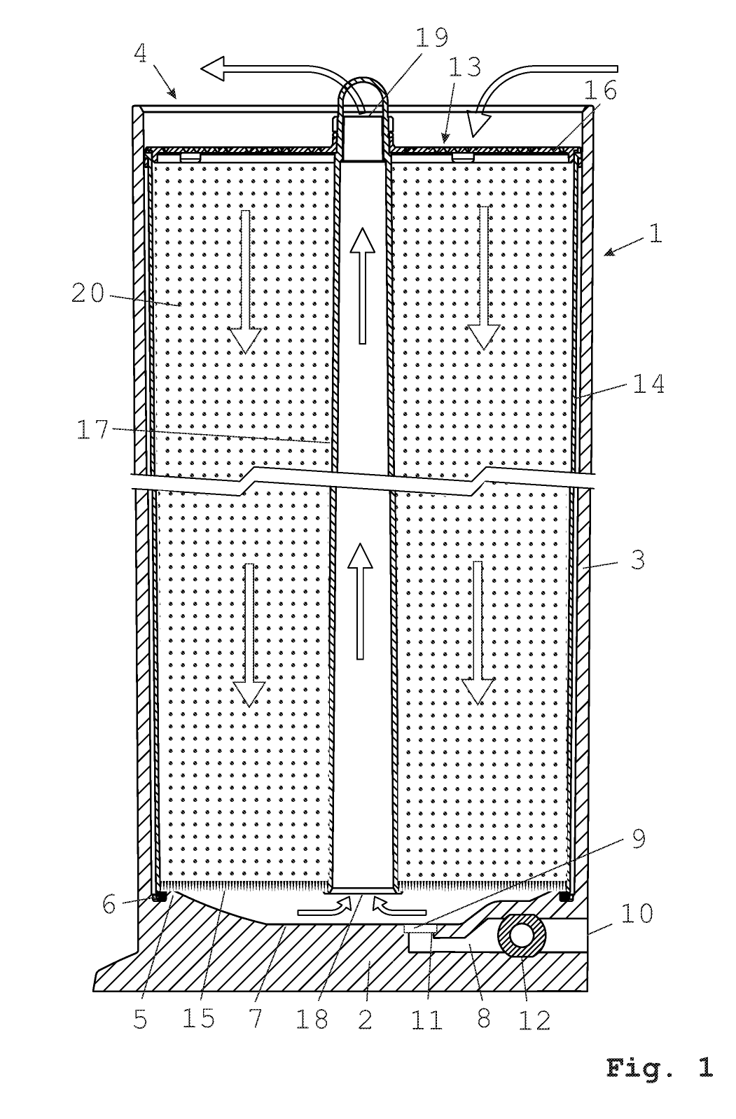

According to FIG. 1, an essentially cylindrical filter cartridge 13 inserted into the cavity 4 is configured as an ion exchanger filter cartridge. The filter cartridge 13 presents a plastic housing with a circumferential cartridge wall 14 that is surrounded by the side wall 3 of the container 1 with little clearance, and with a cartridge bottom 15 and a cartridge lid 16. In addition, a return line 17 is arranged in the center and surrounded by the cartridge wall 14 with a clearance, the return line leading from an inlet opening 18 above the depression 7 to an outflow opening 19 in the center of the opening of the cavity 4 where a drain line configured as a tube which is laterally closed, i.e., impermeable for liquid, can be connected. The cartridge wall 14, the return line 17, the cartridge bottom 15 and the cartridge lid 16 enclose a filter compartment filled with a filter material 20, a filter granulate made of ion exchange resin. The cartridge bottom 15 is configured as a retainer screen having a plurality of openings with a smaller diameter than the particle size of the filter granulate. The edge of its underside as well as the lower edge of the cartridge wall 14 abut the sealing ring 6. The cartridge lid 16 is also provided with a plurality of openings. The ball valve 12 is closed.

In use, the liquid to be filtered, mostly saline water, is introduced through the opening of the cavity 4 with a pressure of, e.g., between 3 bar and 15 bar and flows vertically through the openings in the cartridge lid 16, through the filter material 20 and through the openings in the cartridge bottom 15, downward into the space between the bottom 2 of the container 1 and the cartridge bottom 15, where the liquid is cleaned by the interaction with the filter material 20 in that the solutes are replaced with water. The cleaned liquid then rises from the inlet opening 18 through the return line 17 to the outflow opening 19 where the cleaned liquid can be drawn off via a connected line (not shown). If a throttle valve is inserted into the extension 11, this does not affect the functionality, since no liquid flows through the drain line 8. The filtering capacity is dependent on the pressure and can reach about 10 l/min at 3 bar, and 20 l/min at 6 bar.

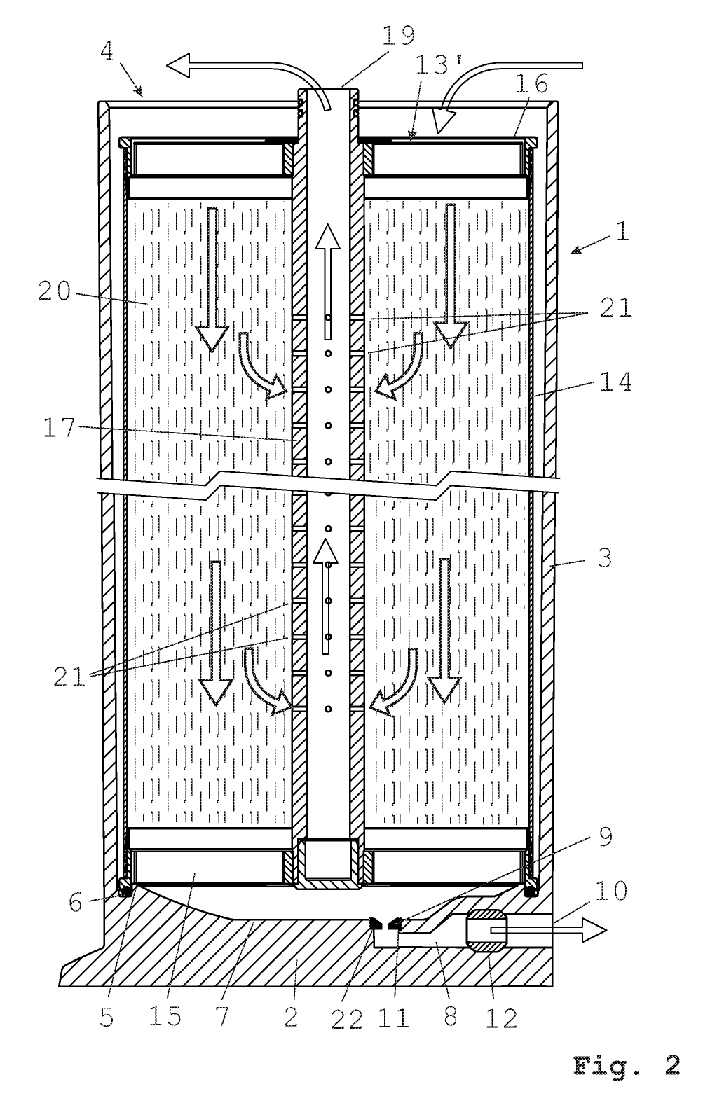

According to FIG. 2, the filter cartridge 13′ inserted into cavity 4 of the same container 1 is configured as a reverse osmosis filter cartridge. The basic structure is the same as that of the ion exchanger filter cartridge; therefore, only differing components will be described.

The filter material 20 is configured as a coil of a selectively semipermeable diaphragm that lets water pass, but retains substances dissolved in the water. Since the filter material 20 is solid, the cartridge bottom 15 and the cartridge lid 16 are provided with larger openings. A circumferential edge strip of the cartridge bottom 15 abuts the sealing ring 6. The return line 17 is again configured as a tube; here, however, the return line 17 is provided with holes 21 distributed along its extension. A throttle valve is inserted into the extension 11, the valve being configured as a backpressure valve. In this example, the valve is an apertured diaphragm 22 having a centrally passing channel following a conically narrowing portion, the channel having a diameter of between 1.5 mm and 3 mm, e. g., 2 mm, and a length of between 8 mm and 15 mm, e. g., 10 mm. The ball valve 12 is open.

Again, the liquid to be filtered is in use introduced through the opening in the cavity 4 under a pressure of between 3 bar and 15 bar, and flows through the openings in the cartridge lid 16 into the filtering material 20. There, a part of the liquid is pressed through the windings of the diaphragm and thus cleaned; after that the liquid enters, through the holes 21, the return line 17, where the liquid rises to the outflow opening 19. The remaining part of the liquid, being enriched with the dissolved substances, enters through the openings in the cartridge bottom 15 into the space between the latter and the bottom 2 of the container 1, whence the liquid reaches, through the apertured diaphragm 22 and further through the drain line 8, the drain opening 10 where the liquid appears as a concentrate.

The apertured diaphragm 22 serves to keep the pressure in said space at a certain level and thus to regulate the proportion of the concentrate; it is suitably configured for that purpose. Normally, this pressure is regulated to half the pressure at which the filtering liquid is introduced into the filter cartridge 13′. The higher the pressure in the space, the better the ratio between filtered liquid and concentrate, but the lower the filtering capacity that in addition also depends on the pressure of the liquid introduced. With a ratio of approx. 1:1, the filtering capacity can be about 5 l/min at 3 bar and 10 l/min at 6 bar; this roughly corresponds to half the filtering capacity of an ion exchanger filter cartridge.

### LIST OF REFERENCE SYMBOLS

1 Container
2 Bottom
3 Sidewall
4 Cavity
5 Edge area
6 Sealing ring
7 Depression
8 Drain line
9 Outlet opening
10 Drain opening
11 Extension
12 Ball valve
13 Filter cartridge (ion exchanger filter cartridge)
13′ Filter cartridge (reverse osmosis filter cartridge)
14 Cartridge wall
15 Cartridge bottom
16 Cartridge lid
17 Return line
18 Inlet opening
19 Outflow opening
20 Filter material
21 Apertures
22 Apertured diaphragm

1. A container for a filter cartridge, the container comprising:
a bottom; and
a circumferential side wall connected to the bottom, the container forming a cavity for the filter cartridge that is open on an upper side opposite the bottom, and wherein the bottom includes:
an outlet opening in the cavity,
a drain opening on an outer side of the container, and
a drain line passing through the bottom, the drain line connects the outlet opening with the drain opening and includes a socket for receiving a throttle valve and further includes a stop valve.

2. The container according to claim 1, wherein the upper side of the bottom facing the cavity comprises a circumferential edge area adjoining the side wall, and a central depression surrounded by the edge area, and wherein the outlet opening is situated in the central depression.

3. The container according to claim 2, wherein the bottom includes a sealing ring arranged in a circumferential groove in the edge area.

4. The container according to claim 1, wherein the socket is arranged between the cavity and the stop valve.

5. The container according to claim 4, wherein the socket is arranged near the outlet opening in such a way that the socket is accessible via the cavity.

6. The container according to claim 4, wherein the socket is configured as an extension at a beginning of the drain line.

7. The container according to claim 1, further comprising a throttle valve inserted into the socket.

8. The container according to claim 7, wherein the throttle valve is configured as a backpressure valve.

9. The container according to claim 8, wherein the backpressure valve is an apertured diaphragm with a passing channel with a diameter of between 1.5 mm and 3 mm and a length of between 8 mm and 15 mm.

10. The container according to claim 1, wherein the stop valve is configured as a ball valve.

11. A filter set comprising:
a container including a bottom and a circumferential side wall connected to the bottom, the container forming a cavity for the filter cartridge that is open on an upper side opposite the bottom,
at least one first filter cartridge that can be inserted into the cavity and is configured as an ion exchanger cartridge, and
at least one second filter cartridge that can be inserted into the cavity and is configured as a reverse osmosis cartridge,
wherein the container has
an outlet opening in the cavity,
a drain opening on an outer side of the container, and
a drain line which connects the outlet opening with the drain opening and includes a socket for receiving a throttle valve and further includes a stop valve.

12. The filter set according to claim 11, further comprising a throttle valve that is inserted or can be inserted into the drain line of the container.

13. The filter set according to claim 11, wherein the first filter cartridge and the second filter cartridge each include
a housing that is permeable for liquid on an underside and an upper side opposite thereof and has a circumferential cartridge wall that is impermeable for liquid, the housing comprising a filter compartment filled with filter material, and
a return line surrounded by the cartridge wall with a distance and leading from the underside of the cartridge to an outflow opening arranged on the upper side of the cartridge.

14. The filter set according to claim 11, wherein the outlet opening is disposed on the bottom of the container.

15. The filter set according to claim 14, wherein
the bottom of the container has a sealing ring arranged in a circumferential groove in the edge area, and
the first filter cartridge and the second filter cartridge each include, on their undersides, a cartridge bottom having openings, and on their upper sides, a cartridge lid having openings.
